(19) United States
(12) Patent Application Publication
(10) Pub. No.: US 2025/0253478 A1
(43) Pub. Date: Aug. 7, 2025

(54) BATTERY ASSEMBLY

(71) Applicant: SK On Co., Ltd., Seoul (KR)

(72) Inventor: Jeong Won KIM, Daejeon (KR)

(21) Appl. No.: 19/042,137

(22) Filed: Jan. 31, 2025

(30) Foreign Application Priority Data
Feb. 1, 2024 (KR) 10-2024-0015748

(51) Int. Cl. H01M 50/293; H01M 10/652; H01M 10/6555; H01M 10/658; H01M 50/204; H01M 50/291

(52) U.S. Cl. CPC H01M 50/293; H01M 10/652; H01M 10/6555; H01M 10/658; H01M 50/204; H01M 50/291; H01M 2200/10

(57) ABSTRACT

A battery assembly of the present disclosure includes a plurality of battery cells arranged in a predetermined stacking direction, an accommodation case accommodating the plurality of battery cells, and an insertion member located in an insertion space formed between the accommodation case and the plurality of battery cells in the predetermined stacking direction, wherein the insertion member includes a body portion having a pillar shape, and an expansion portion covering at least a portion of the body portion and expanding when reaching a predetermined allowable temperature.

### CROSS-REFERENCE TO RELATED PATENT APPLICATION

This application claims priority under 35 U.S.C. § 119 (a) to Korean patent application number 10-2024-0015748, filed on Feb. 1, 2024, the disclosure of which is incorporated by reference herein in its entirety.

### BACKGROUND

### 1. Technical Field

The disclosure relates to a battery assembly, and specifically to a battery assembly for delaying thermal propagation.

### 2. Description of the Related Art

Recently, due to fires and explosions which occur during the use of lithium secondary batteries, social concerns about the safety of battery use have been increasing. Based on these social concerns, one of the major development tasks of lithium secondary batteries recently is to eliminate instability such as fires and explosions caused by thermal runaway of battery cells.

In particular, a battery module/pack contains an empty space other than the battery cells, which are the energy source. If a fire occurs due to an external impact or a problem with a battery cell, the flame may spread to adjacent cells through the empty space, increasing the damage caused by the fire. Because this risk of fire could be the biggest obstacle to the electric vehicle market, research is ongoing into ways to reduce the spread of fire.

### SUMMARY

An object to be achieved by the present disclosure is to increase the stability of the battery assembly by increasing the heat resistance or the fire resistance.

In addition, another object to be achieved by the present disclosure is to delay thermal propagation inside the battery assembly.

In addition, the present disclosure may be widely applied to electric vehicles, battery charging stations, and other green technology fields such as solar power generation and wind power generation using batteries.

In addition, the present disclosure may be used in eco-friendly electric vehicles, hybrid vehicles, etc. to prevent climate change by suppressing air pollution and greenhouse gas emissions.

A battery assembly of the present disclosure includes a plurality of battery cells arranged in a predetermined stacking direction, an accommodation case accommodating the plurality of battery cells, and an insertion member located in an insertion space formed between the accommodation case and the plurality of battery cells in the predetermined stacking direction, wherein the insertion member includes a body portion having a pillar shape, and an expansion portion covering at least a portion of the body portion and expanding when reaching a predetermined allowable temperature.

In an embodiment, the body portion may extend in a height direction of the accommodation case.

In an embodiment, the body portion may include a fire-resistant material.

In an embodiment, at least one of opposite ends of the body portion may have a tapered shape.

In an embodiment, a thickness of the expansion portion may be 0.01 mm or more and 100 mm or less.

In an embodiment, a volume of the expansion portion after expansion may be twice or more and ten times or less than a volume of the expansion portion before expansion.

In an embodiment, the expansion portion may contact one of the plurality of battery cells forming the insertion space, when the expansion portion expands.

In an embodiment, the battery assembly may further include a bus bar assembly electrically connecting the plurality of battery cells, wherein the insertion space is located between the bus bar assembly and the plurality of battery cells.

In an embodiment, the insertion space may be separated into a plurality of separation spaces by tap portions of the plurality of battery cells, and the insertion member may be inserted into one or more of the plurality of separation spaces.

In an embodiment, the expansion portion may contact one or more of the tap portions forming the separation spaces, when the expansion portion expands.

In an embodiment, the expansion portion may contact the bus bar assembly forming the separation spaces, when the expansion portion expands.

In an embodiment, the battery assembly may further include a heat blocking member located between the plurality of battery cells to face an adjacent battery cell.

In an embodiment, the battery assembly may further include a heat dissipation portion including an adhesive material applied to the accommodation case and having thermal conductivity.

In an embodiment, the accommodation case may include an accommodation body including an open upper face and accommodating the plurality of battery cells through the open upper face and an accommodation cover combined with the accommodation body and closing the open upper face.

In an embodiment, the expansion portion may have a latex form or an aerogel form.

In an embodiment, the insertion member may include a plurality of insertion members.

In an embodiment, a melting point of the body portion may be higher than the predetermined allowable temperature.

According to an embodiment of the present disclosure, the stability of a battery assembly may be increased by increasing heat resistance or fire resistance.

According to an embodiment of the present disclosure, thermal propagation of a battery assembly may be delayed.

### BRIEF DESCRIPTION OF THE DRAWINGS

FIG. 1 illustrates a battery assembly according to an embodiment of the present disclosure.

FIG. 2 is an exploded view of a battery assembly according to an embodiment of the present disclosure.

FIG. 3 illustrates a battery assembly according to an embodiment of the present disclosure viewed from above.

FIGS. 4 and 5 each shows an enlarged view of a part S1 of FIG. 3.

FIGS. 6, 7A, and 7B illustrate an insertion member according to an embodiment of the present disclosure.

FIGS. 8 and 9 illustrate an insertion member according to another embodiment of the present disclosure.

FIG. 10 illustrates a state in which an insertion member is located in an insertion space according to an embodiment of the present disclosure.

FIG. 11 illustrates a battery assembly according to another embodiment of the present disclosure.

### DETAILED DESCRIPTION

The structural or functional descriptions of examples disclosed in the present specification or application are merely illustrated for the purpose of explaining examples according to the technical principle of the present invention, and examples according to the technical principle of the present invention may be implemented in various forms in addition to the examples disclosed in the specification of application. In addition, the technical principle of the present invention is not construed as being limited to the examples described in the present specification or application.

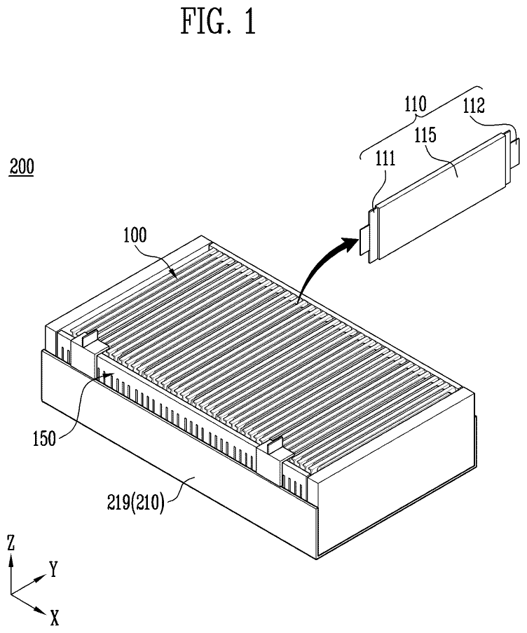

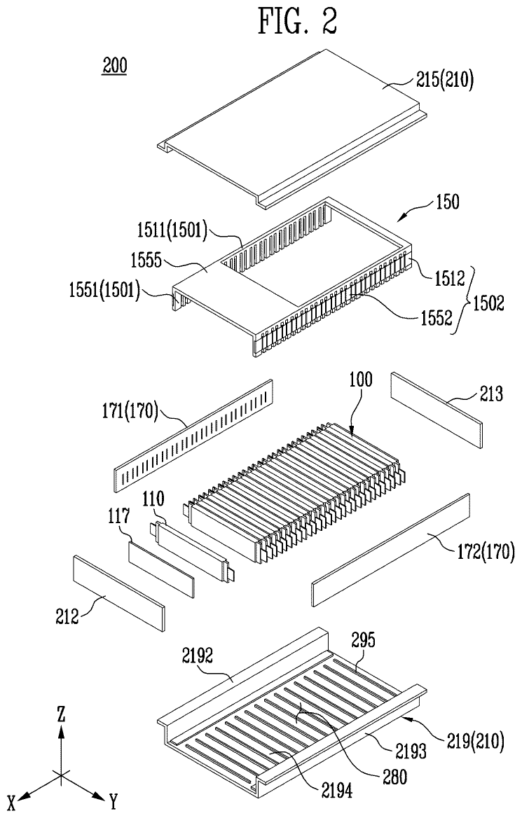

FIG. 1 illustrates a battery assembly according to an embodiment of the present disclosure and FIG. 2 is an exploded view of the battery assembly according to the embodiment of the present invention.

Battery assemblies 200 and 300 according to the present disclosure may collectively refer to a battery module 200 or a battery pack 300. Therefore, the battery assemblies 200 and 300 according to the present disclosure may refer not only to the battery module 200 but also to the battery pack 300 that accommodates a battery cell 110 without the battery module 200, such as a Cell to Pack (CTP).

The battery assemblies 200 and 300 include a plurality of battery cells 110 arranged in a predetermined stacking direction and an accommodation case 210 accommodating the plurality of battery cells 110.

Each of the plurality of battery cells 110 may include a main body 115 that produces or stores electrical energy, and tab portions 111 and 112 protruding from the main body 115 to the outside of the main body 115. The main body 115 may include an electrode assembly (not shown) including an anode, a cathode, and a separator therein for the production and storage of electrical energy.

The main body 115 may further include an electrolyte (not shown) in contact with the electrode assembly. Referring to FIG. 1, the main body 115 may have a pouch form sealed with a film-shaped exterior material.

FIG. 1 illustrates an example of the battery cell 110 with the pouch form, but is not limited thereto. Therefore, the embodiments may also be applied to the battery cells 110 having a rectangular and cylindrical shape.

The tab portion may include a first tab portion 111 and a second tab portion 112 protruding from opposite sides of the body portion 115 in a direction away from the body portion 115. As an example, the tab portion may have opposite tabs on one side. The first tab portion 111 and the second tab portion 112 may be a positive tab and a negative tab, respectively.

For example, the tab portion may protrude in a Y direction. The first tab portion 111 may be located at an end portion in a −Y-axis direction from the main body 115, and the second tab portion 112 may be located at the end portion in a +Y-axis direction.

On the other hand, the accommodation case 210 may protect the plurality of battery cells 110 from external shocks such as vibration. The accommodation case 210 may include an accommodation body 219 that forms a portion of an accommodation space 280 for accommodating the plurality of battery cells 110 to be described later.

In addition, the battery assembly may further include a bus bar assembly 150 electrically connecting the plurality of battery cells 110 and the outside. A form in which the bus bar assembly 150 or a bus bar 151 to be described later is assembled with the plurality of battery cells 110 may be referred to as a cell stacking assembly 100.

FIG. 2 is an exploded view of the battery assembly 200 according to an embodiment of the present disclosure. Referring to FIG. 2, the accommodation case 210 may include the accommodation body 219 that forms the portion of the accommodation space 280 accommodating the plurality of battery cells 110, and an accommodation cover 215 that is coupled to the accommodation body 219 to form the accommodation space 280 together.

The plurality of battery cells 110 may be located in the accommodation body 219 to overlap in the predetermined stacking direction (e.g., a X direction).

More specifically, the accommodation case 210 may further include the accommodation body 219 that encompasses an open upper face and receives the plurality of battery cells 110 through the open upper face, and the accommodation cover 215 that is coupled to the accommodation body 219 to close the open upper face.

Accordingly, the accommodation cover 215 may be coupled to the accommodation body 219 to form an upper face of the accommodation space 280 or an upper face of the accommodation case 210. In other words, the accommodation cover 215 may be coupled to the accommodation body 219 to close the open upper face of the accommodation body 219, and the accommodation space 280 may be formed together with the accommodation body 219.

The accommodation space 280 may be formed in the accommodation body 219 and may include a space for accommodating the cell stacking assembly 100. The accommodation space 280 may further include an insertion space 288 to be described later.

Meanwhile, the accommodation body 219 may have a channel shape or a U-shape with an open upper portion. Referring to FIG. 2, opposite side faces of the accommodation body 219 facing each other in the X direction may also be opened.

That is, the accommodation body 219 may include a body bottom face 2194 forming the accommodation space 280 and body side faces 2192 and 2193 extending toward the accommodation cover 215 at corners (not shown) provided side by side in the stacking direction among the corners of the body bottom face 2194. The free ends of the body side faces 2192 and 2193 may be bent to form flanges (not shown) to be easily coupled with the accommodation cover 215.

The battery assembly 200 may further include insulating covers 170, 171, and 172. The insulating covers 170, 171, and 172 may protect the tab portions 111 and 112 of the plurality of battery cells 110. The insulating covers 170, 171, and 172 may be located at which the tab portions 111 and 112 of the plurality of battery cells 110 protrude. For example, the insulating covers 170, 171, and 172 may face the end portion in the −Y-axis direction and the end portion in the +Y-axis direction of the battery cell 110, respectively.

Referring to FIGS. 1 and 2, the height of the accommodation body 219 may be smaller than the heights of the plurality of battery cells 110. However, this is only an example, and the height of the accommodation body 219 may be greater than or equal to the height of the plurality of battery cells 110.

The height of the accommodation body 219 may refer to the length of the accommodation body 219 measured in a direction perpendicular to the direction in which the tab portion protrudes. For example, the height direction of the accommodation body 219 may be parallel to a Z-axis. Meanwhile, the X-axis, the Y-axis, and the Z-axis may be formed perpendicular to each other.

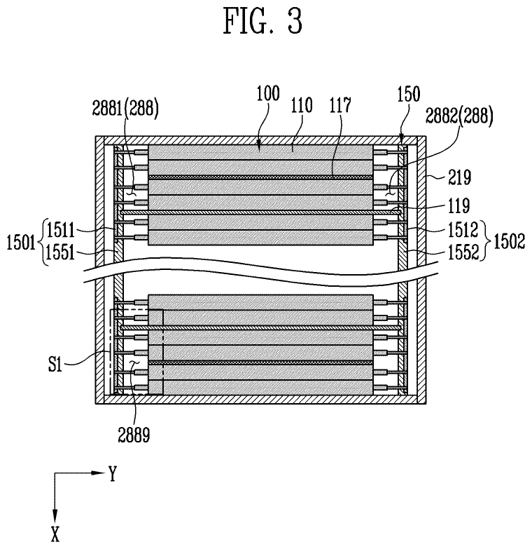

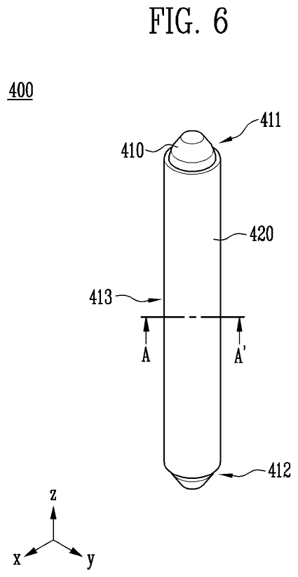

The cell stacking assembly 100 may further include a buffer member 117 or a heat blocking member 119 (refer to FIG. 3) located between the plurality of battery cells 110. The buffer member 117 may be located between the battery cells 110. The buffer member 117 may also be located between battery groups BG (refer to FIG. 6) in which the plurality of battery cells 110 are grouped. The same configuration may also be applied to the heat blocking member 119.

The heat blocking member 119 may serve as a thermal barrier to prevent flames or heat from spreading to other adjacent battery cells 110 when one battery cell 110 is thermally runaway.

The cell stacking assembly 100 may include at least one buffer member 117. Similarly, the cell stacking assembly 100 may include at least one heat blocking member 119. The buffer member 117 and the heat blocking member 119 may be formed as a single member to simultaneously perform the heat blocking function and the shock absorbing function.

To this end, the heat blocking member 119 may also have a multi-layer structure in the stacking direction of the plurality of battery cells 110. In other words, one layer of the multi-layer structure may include a flame retardant material (or a fire-resistant material). In addition, other layers of the multi-layer structure may reduce pressure on the other battery cells 110 when the battery cells 110 are swollen.

The plurality of battery cells 110 and the plurality of buffer members 117 may be stacked in a predetermined position. For example, referring to FIG. 2, an example in which long edges of the plurality of battery cells 110 are located in parallel in the Y direction is shown. Therefore, the plurality of battery cells 110 and the plurality of buffer members 117 may overlap in the X direction. The same configuration may be applied to the heat blocking member 119.

The heat blocking member 119 may include a fire-resistant (heat-resistant or flame-resistant) material. For example, the heat blocking member 119 may include a material such as a refractory polymer or mica.

Meanwhile, referring to FIG. 2, the battery assembly may further include end plates 212, 213 at opposite ends of the cell stacking assembly 100 in the stacking direction. The end plates 212 and 213 may be located at the opposite ends of the cell stacking assembly 100 or may be formed by being connected to the opposite side faces of the accommodation body 219.

The end plates 212 and 213 may prevent opposite sides of the cell stacking assembly 100 from being exposed to the outside.

Meanwhile, the battery assembly may include the bus bar 151 electrically connected to the plurality of battery cells 110. In addition, the battery assembly may further include a bus bar frame 155 supporting the bus bar 151 and the battery cell 110. The bus bar 151 and the bus bar frame 155 may be collectively referred to as the bus bar assembly 150. That is, the bus bar assembly 150 may include the bus bar 151 electrically connected to the plurality of battery cells 110.

The bus bar assembly 150 may be electrically connected to the outside to store (or charge) electrical energy in the plurality of battery cells 110 or to supply (or discharge) electrical energy stored in the plurality of the battery cells 110 to the outside.

The bus bar assembly 150 may include a first bus bar frame 1551 and a second bus bar frame 1552 extending in the stacking direction of the plurality of battery cells 110 with the plurality of battery cells 110 interposed therebetween.

In addition, the bus bar assembly 150 may further include a support frame 1555 located on one side of the bus bar assembly 150 and connects the first bus bar frame 1551 and the second bus bar frame 1552.

FIG. 2 illustrates the bus bar assembly 150 using a case where the tab portions are respectively located in opposite directions of the main body 115. Alternatively, when the tab portion is located on one side of the main body 115 and is located in the same direction, the bus bar frame 155 may be located on one side, for example, on an upper portion of the main body 115 and electrically connected to the tab portion.

The support frame 1555 may prevent and support deformation of the first bus bar frame 1551 and the second bus bar frame 1552. In addition, a portion of the electrical device for sensing and controlling the plurality of battery cells 110 may be disposed on the support frame 1555.

Referring to FIG. 2, the bus bar assembly 150 may have a tunnel shape. The length of the first bus bar frame 1551 and the length of the second bus bar frame 1552 in the stacking direction may be longer than the length of the support frame 1555.

That is, the support frame 1555 may be connected to the first bus bar frame 1551 and the second bus bar frame 1552 to cover upper portions of the plurality of battery cells 110. That is, the support frame 1555 may cover not only some of the upper portions of the plurality of battery cells 110 but also all of the upper portions.

Referring to FIG. 2, the bus bar 151 may include a first bus bar 1511 supported by the first bus bar frame 1551 and electrically connected to the first tab portion 111, and a second bus bar 1512 supported by the second bus bar frame 1552 and electrically connected to the second tab portion 112.

The first bus bar 1511 and the second bus bar 1512 may be located farther away from the plurality of battery cells 110 than the first bus bar frame 1551 and the second bus bar frame 1552, respectively. That is, the first bus bar 1511 and the second bus bar 1512 may be located closer to the body side faces 2192 and 2193 than the first bus bar frame 1551 and the second bus bar frame 1552. Therefore, the first tab portion 111 and the second tab portion 112 may be inserted into slit holes (not shown) formed in the first bus bar frame 1551 and the second bus bar frame 1552, respectively, to be electrically connected to the first bus bar 1511 and the second bus bar 1512. However, this is only an example, and the first tab portion 111 and the second tab portion 112 may respectively be electrically connected to the first bus bar 1511 and the second bus bar 1512 in a different manner.

The battery assembly may further include a heat dissipation portion 295 located between the body bottom face 2194 and the plurality of battery cells 110 to propagate heat generated in the plurality of battery cells 110 to the outside of the battery assembly.

The heat dissipation portion 295 may be provided with an adhesive material having thermal conductivity, for example, a heat dissipation adhesive. Therefore, the plurality of battery cells 110 may be bonded to the body bottom face 2194 through the heat dissipation portion 295. To this end, the heat dissipation portion 295 may be applied or sprayed onto the body bottom face 2194.

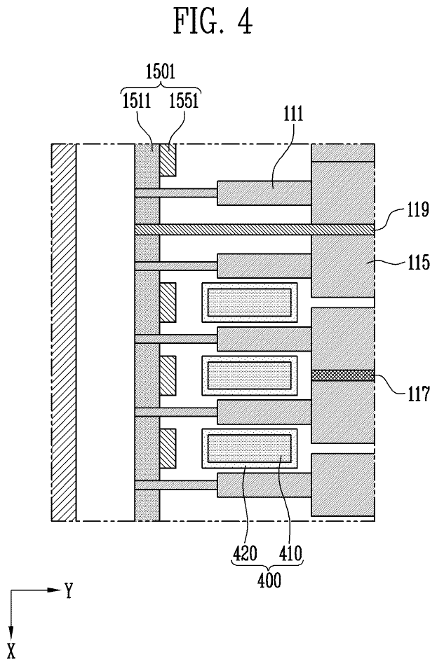

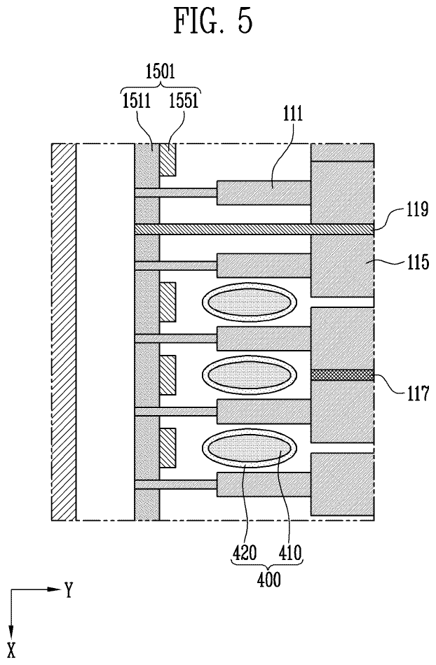

FIG. 3 illustrates a battery assembly according to an embodiment of the present disclosure viewed from above and FIGS. 4 and 5 each shows an enlarged view of a part S1 of FIG. 3.

The battery assembly according to the present disclosure may include an insertion member 400 located in an insertion space formed between the accommodation case 210 and the plurality of battery cells in the predetermined stacking direction, and the insertion member 400 may include a body portion 410 having a cylindrical shape and an expansion portion 420 covering at least a portion of the body portion and expanding when a predetermined allowable temperature is reached.

The insertion space 288 may be a portion of the accommodation space 280 (refer to FIG. 2). The insertion space 288 may be a space in which the accommodation space 280 is partitioned by components. In other words, the insertion space 288 may be formed by components of the battery assembly including the accommodation body and the accommodation cover.

Specifically, the insertion space 288 may be located between the bus bar assembly 150 and the plurality of battery cells 110. The accommodation space 280 may be formed over the accommodation body 219 and the bus bar assembly 150 may be located over the accommodation space 280. The insertion space 288 may be formed by the bus bar assembly 150 and the plurality of battery cells 110 over the accommodation body 219.

More specifically, the insertion space 288 may be located between the first bus bar frame 1551 and the plurality of battery cells 110, and between the second bus bar frame 1552 and the plurality of the battery cells 110. That is, the insertion space 288 may be formed on opposite sides of the plurality of battery cells on which the tab portions protrude.

The battery assembly may include the insertion member 400 to increase heat resistance or fire resistance. The insertion member 400 may be located in the accommodation space 280. Specifically, the insertion member 400 may be located in the insertion space 288.

Heat or fire may be generated due to thermal runaway of one of a plurality of battery cells. The heat generated from the battery cells accommodated in the accommodation case is rapidly propagated to the adjacent battery cells and the battery assembly may be completely burned in a short time. In particular, fire or heat may be propagated through the insertion space formed between the plurality of battery cells and the accommodation case.

The battery assembly according to an embodiment of the present disclosure may block the propagation path of heat or flame during thermal runaway by positioning the insertion member 400 including the expansion portion 420 in the insertion space 288. The thermal propagation of the battery assembly may be delayed accordingly.

FIG. 3 illustrates the battery assembly according to an embodiment of the present disclosure viewed from above.

The bus bar assembly 150 may include the first bus bar 1511 electrically connected to the first tab portion 111 and the first bus bar frame 1551 supporting the first bus bar 1511. The first bus bar 1511 and the first bus bar frame 1551 may be collectively referred to as a first bus bar assembly 1501. That is, the first bus bar assembly 1501 may be electrically connected to the first tab portion 111 to support the cell stacking assembly 100.

The bus bar assembly 150 may include the second bus bar 1512 electrically connected to the second tab portion 112 and the second bus bar frame 1552 supporting the second bus bar 1511. The second bus bar 1512 and the second bus bar frame 1552 may be collectively referred to as a second bus bar assembly 1502. That is, the second bus bar assembly 1502 may be electrically connected to the second tab portion 112 to support the cell stacking assembly 100.

Referring to FIG. 3, an empty space may be formed between the plurality of battery cells 110 and the bus bar assembly 150 due to the electrical connection between the tab portions 111 and 112 and the bus bar assembly 150. The empty space may be the insertion space 288 described above.

That is, a portion of the accommodation space 280 formed in the accommodation case 210 may be a space for accommodating the plurality of battery cells 110 and another portion of the accommodation spaces 280 may be a space of the insertion space 288.

Specifically, the insertion space 288 is a space formed by each of the main body 115, tab portions 111 and 112, and the bus bar 151. When thermal runaway occurs in one of the plurality of battery cells 110 and off-gas occurs, high-temperature heat may propagate to other adjacent battery cells 110 through the insertion space 288.

As described above, the insertion member 400 of the present disclosure may be located in the insertion space 288 to delay or prevent the propagation of heat and flame.

Referring to FIG. 3, on the other hand, the buffer member 117 may be located between the plurality of battery cells 110. The buffer member 117 may be located between each of the plurality of battery cells 110. Alternatively, the buffer member 117 may be located between battery groups in which adjacent battery cells 110 are grouped in a predetermined number.

Referring to FIG. 3, the length of the buffer member 117 in the direction from the first bus bar frame 1551 toward the second bus bar frame 1552 is illustrated as being less than or equal to the length of the main body 115, but is not limited thereto.

Meanwhile, referring to FIG. 3, the heat blocking member 119 may be located between the plurality of battery cells 110. The heat blocking member 119 may be located between each of the plurality of battery cells 110. Alternatively, the heat blocking member 119 may be located between the battery groups in which the adjacent battery cells 110 are grouped in the predetermined number.

The battery group BG refers to a set of battery cells 110 in which the adjacent battery cells 110 are stored in the predetermined number among the plurality of battery cells 110. The plurality of battery cells 110 may be grouped into groups for a predetermined target voltage or target current, and then the battery groups may be connected in series or in parallel using the bus bar 151.

Referring to FIG. 3, the length of the buffer member 117 in the direction from the first bus bar frame 1551 toward the second bus bar frame 1552 is shown to be less than or equal to the length of the main body 115, but is not limited thereto.

Meanwhile, referring to FIG. 3, the heat blocking member 119 and the buffer member 117 are illustrated as being separated from each other, but alternatively, as described above, they may be formed as one member. In the case where the heat blocking member 119 and the buffer member 117 are formed in the one member may be referred to as an auxiliary member (not shown). That is, the auxiliary member may be located between the plurality of battery cells 110 to buffer the surface pressure of the battery cell 110 during thermal runaway and swelling.

The length of the heat blocking member 119 in the direction from the first bus bar frame 1551 toward the second bus bar frame 1552 may be longer than the length of the main body 115. More specifically, the heat blocking member 119 may be in contact with the first bus bar assembly 1501 and the second bus bar assembly 1502. In this way, the heat blocking member 119 may block or delay the propagation of heat or flame to other places when the battery cell 110 is thermally runaway.

FIGS. 4 and 5 each shows an enlarged view of the part S1 of FIG. 3.

Specifically, the part S1 may be an area of the insertion space 288. The battery assembly may further include the insertion space 288 formed between the cell stacking assembly 100 and the bus bar assembly 150 or the plurality of battery cells 110 and the bus bar 151.

Specifically, the battery assembly may include a first insertion space 2881 (refer to FIG. 3) and a second insertion space 2882 (refer to FIG. 3) between one side of the main body 115 of each of the plurality of battery cells 110 and the first bus bar 1511, and between the other side of main body 115 of each of the plurality the battery cells 110 and the second bus bar 1512.

Referring to FIGS. 4 and 5, the insertion member 400 may be located in at least one of the first insertion space 2881 and the second insertion space 2882. In FIG. 3, the shape of the insertion member 400 is not specifically illustrated and only the position of the insertion member 400 is illustrated in order to emphasize that the insertion member 400 is located in the insertion space 288.

That is, the insertion member 400 may be located in at least one of the first insertion space 2881 and the second insertion space 2882.

More specifically, the part S1 of FIG. 4 illustrates a part of the first insertion space 2881. The first tab portion 111 may be located at one side face of the main body 115, and the second tab portion 112 may be located at the other side face of the body 115.

Meanwhile, the first insertion space 2881 may be separated by the first tab portion 111. In addition, the second insertion space 2882 may be separated by the second tab portion 112. However, when the cell stacking assembly 100 is accommodated in the accommodation body 219, since the lengths of the first tab portion 111 and the second tab portion 112 in the height direction of the accommodation case 210 or the accommodation body 219 are smaller than the height of the battery cell 110, each of the first insertion space 2881 and the second insertion space 2882 may communicate with each other.

In addition, the first insertion space 2881 and the second insertion space 2882 may communicate with each other through a space between the plurality of battery cells 110 and the accommodation cover 215. Therefore, the first insertion space 2881 and the second insertion space 2882 may not be separated and isolated from each other, but may communicate with each other.

Meanwhile, the insertion space 288 may include a plurality of separation spaces 2889 separated by each tab portion. Each tab portion may not separate the plurality of separation spaces 2889 in an isolated manner. That is, since the length of each of tab portions in the height direction of the accommodation case 210 is smaller than the height of the accommodation space 280, only at least a portion of the plurality of separation spaces 2889 may be distinguished in the height of the accommodation space 280.

That is, since the length of each tab portion along the height direction of the accommodation case 210 is smaller than the length of each main body 115, the plurality of insertion spaces 288 may be separated by each tab portion or may communicate with each other.

More specifically, the plurality of first insertion spaces 2881 may be formed by the first tab portion 111, and the plurality of separation spaces 2889 formed in the first insertion space 2881 may communicate with each other. The plurality of second insertion spaces 2882 may be formed by the second tab portion 112, and the plurality of separation spaces 2889 formed in the second insertion space 2882 may communicate with each other. The insertion member 400 may include a plurality of insertion members 400 and the plurality of insertion members 400 may be respectively inserted into the plurality of separation spaces 2889.

Referring to FIG. 4, the heat blocking member 119 may be located in parallel with the plurality of battery cells 110 and extend to the bus bar assembly 150. More specifically, the heat blocking member 119 may extend to and be inserted into the bus bar frame 155. In this case, the insertion member 400 may not be inserted into the space into which the heat blocking member 119 is inserted to prevent interference between the insertion member 400 and the heat blocking member 119.

Referring to FIGS. 4 and 5, the insertion member 400 may be inserted into at least a part of the plurality of separation spaces 2889. The insertion member 400 may be located in at least one of the plurality of separation spaces 2889 of two adjacent battery cells 110.

The insertion member 400 may extend in the height direction of the accommodation case 210 in the separation space 2889. For example, the insertion member 400 may extend in the +Z direction. However, the shape of the insertion member 400 may be variously formed.

In an embodiment, a cross section of the insertion member 400 cut along the height direction of the accommodation case 210 may have a shape of a polygon, a circle, an ellipse, or a combination thereof. Referring to FIG. 4, the insertion member 400 may have a rectangular cross section and referring to FIG. 5, the insertion member 400 may have an elliptical cross section.

The shape of the insertion member 400 is not limited as long as the insertion member 400 may be inserted and located in a predetermined insertion space.

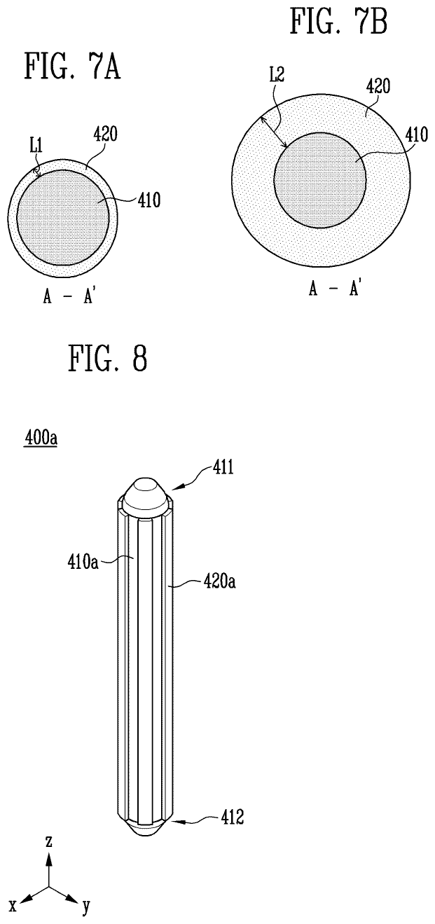

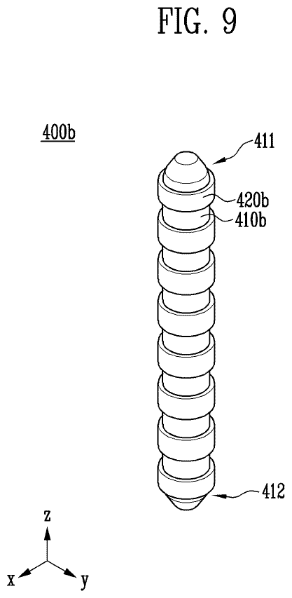

FIGS. 6, 7A and 7B illustrate the insertion member 400 according to an embodiment of the present disclosure, and FIG. 8 and FIG. 9 illustrate the insertion member 400 according to another embodiment of the present disclosure.

Referring to FIGS. 6, 7A, and 7B, the insertion member 400 may include the body portion 410 having a predetermined size and the expansion portion 420 covering at least a portion of the body portion 410 and expanding when a predetermined allowable temperature is reached.

The body portion 410 may have a predetermined size. The body portion 410 may extend in the height direction (e.g., the Z direction) of the accommodation case 210. The body portion 410 may have a column shape. As a result, the body portion 410 may be stably located in the insertion space 288, and the expansion portion 420 covering the insertion member 400 may be uniformly distributed in the height direction of the accommodation case 210. In an embodiment, the insertion member 400 may be adhered to the accommodation case 210 by the heat dissipation portion 295.

At least one of opposite ends of the body portion 410 may have a tapered shape. At least one of one end 411 of the body portion 410 (refer to FIG. 6) and the other end 412 opposite to the one end 411 (see FIG. 6) may have a tapered shape. In this way, the insertion member 400 may be stably located in the insertion space 288 or may be easily inserted into the insertion space.

Meanwhile, the opposite ends of the body portion 410 may have the same shape. As a result, the battery assembly may be manufactured without considering the insertion direction of the insertion member 400, thereby improving the manufacturing efficiency.

Meanwhile, the body portion 410 may include a fire-resistant material or a flame-retardant material. The body portion 410 may include a material having a flame retardant grade of V-0 or higher according to the UL94 standard. The UL94 standard is a classification of flame retardant grades based on tests that evaluate flame retardancy for plastics. Flame-retardant grades are classified into HB, V2, V1, V0, and 5V. V2 grade materials have the lowest flame retardancy and are easily burned and 5V grade materials have the least flame retardancy.

The body portion 410 of the present disclosure may include a material having V2 grade or higher. For example, the body portion 410 may include at least one material among flame-retardant polyurethane, silicone, modified polyphenylene oxide (MPPO), polypropylene, polyoxymethylene acetal, polyamide 6, polyamide 6-6, and polycarbonate. The above-described flame-retardant materials are only an embodiment and are not limited thereto. Any known material with fire-resistant properties may also be used.

The melting point of the body portion 410 may preferably be higher than a predetermined allowable temperature at which the expansion portion 420 starts to expand that will be described later, such that the body portion 410 may not melt or be damaged even when the expansion portion 420 expands.

The expansion portion 420 may cover at least the portion of the body portion 410. The expansion portion 420 may cover an outer surface of the body portion 410 and may cover all or a portion of the body portion 420. The expansion portion 420 may cover the outer surface of the body portion 410 having a uniform thickness. Preferably, the expansion portion 420 may cover a central portion 413 connecting one end and the other end of the body portion 410. When the body portion 410 extends in the height direction of the accommodation case 210, the expansion portion 420 may cover the central portion 413 of the body portion 410 in a direction in which the body portion 410 is extended.

The expansion portion 420 may cover the central portion 413 of the body portion 410 so as to maximize the coverage of the expansion portion 420 and improve the stability of the battery assembly. When the expansion portion 420 is located at the one end and the other end of the body portion 410 and expands, the expansion portion 420 may press the accommodation case 210 and may cause damage to the accommodation case 210. Therefore, the expansion portion 420 may be preferably located at the central portion 413 of the body portion 410 to expand in a circumferential direction of the body portion 410 having a cylindrical shape.

The expansion portion 420 may be coated or applied to the outside of the body portion 410. The thickness of the expansion portion 420 may be 0.01 mm or more and 100 mm or less to efficiently cover the insertion space and prevent the battery assembly from being pressed due to excessive expansion of the expansion portion 420. For example, when the thickness of the expansion portion 420 is too thin, the insertion space may not be covered, and when the thickness of the expansion portion 420 is too thick, the expansion portion 420 may be excessively expanded and damage may occur by pressing adjacent components.

The thickness of the expansion portion 420 may refer to a length of the expansion portion 410 measured in a direction perpendicular to a direction in which the body portion 410 extends. The thickness of the expansion portion 420 may be calculated by measuring the difference in distance between the body portion 410 and the boundary between the expansion portion 420 at the distance from the center (or center of gravity) of the body portion 410 to the outermost part.

The thickness of the expansion portion 420 may be the maximum thickness of the expansion portions 420. In contrast, the thickness of the expansion portion 420 may be an average value calculated after being measured in various directions from the center of the body portion 410.

Referring to FIGS. 6, 7A, and 7B, the expansion portion 420 may cover the entire area of the body portion 410 in the circumferential direction. In contrast, expansion portions 400a and 400b may cover only the portion of the body portion 410 in the circumferential direction. For example, referring to FIG. 8, an expansion portion 420a may be spaced apart in the circumferential direction, but may extend in the height direction of the accommodation case 210 to be coated on the outside of a body portion 410a.

Referring to FIG. 9, an expansion portion 420b may cover a portion of the body portion 410b in the circumferential direction, but may be spaced apart in the height direction of the accommodation case 210. In other words, the expansion portions 420a and 420b may be spaced apart from each other and located on the opposite sides of the body portion 410, and may expand when each of the expansion portions 420a and 420b reaches the predetermined allowable temperature.

The expansion portion 420 may expand when reaching the predetermined allowable temperature. The predetermined allowable temperature may be 80° C. (Celsius temperature) or more and 150° C. or less. When thermal runaway of the battery assembly occurs, the temperature inside the battery assembly may rise to 100° C. or higher. Accordingly, the expansion portion 420 may have expand when the temperature of the battery assembly increases in order to delay the propagation of heat and flame.

The expansion portion 420 may expand by two times or more and ten times or less. A volume of the expansion portion after expansion may be twice or more and ten times or less than a volume of the expansion portion before expansion. In an embodiment, when the expansion portion 420 expands in the thickness direction of the expansion portion 420, a thickness of the expansion portion 422 after expansion may be twice or more and ten times or less than a thickness of the expansion portion before expansion.

FIG. 7A illustrates a cross section of the expansion portion before expansion and FIG. 7B illustrates a cross section of the expansion portion after expansion. Referring to FIGS. 7A and 7B, a thickness L2 after expansion may be greater than or equal to two times and less than or equal to 10 times a thickness L1 before expansion.

In an embodiment, the expansion portion 420 may be located outside the body portion in a colloidal form such as latex. Alternatively, the expansion part may be located outside the body part in the form of an aerogel.

When the expansion portion 420 expands, the expansion portion 420 may be in contact with an adjacent component. Specifically, the expansion portion 420 may be in contact with one of the plurality of battery cells 110. As described above, the expansion portion 420 may be located in the separation space formed by the battery cell, and when the expansion portion 420 expands, the separation space fills the space.

In addition, when the expansion portion 420 expands, the expansion portion 420 may be in contact with at least one tab portion forming the separation space. The at least one tab portion may refer to a tab portion that forms a separation space in which the expansion portion 420 is located. Similarly, the expansion portion 420 may expand to fill the separation space. In addition, when the expansion portion 420 expands, the bus bar assembly forming the separation space may be in contact with the bus bar assembly. The bus bar assembly may refer to a bus bar assembly that forms a separation space in which the expansion portion 420 is located.

Specifically, when the expansion portion 420 expands, the expansion portion 420 may simultaneously contact one of the battery cell, the tab portion, and the bus bar assembly. The expansion portion 420 may be in contact with respective one of the plurality of battery cells forming the separation space, the tab portion located in the plurality of battery cells, and the bus bar assembly at the same time.

Before the expansion portion 420 expands, the expansion portion 420 may not contact one of the battery cell, the tab portion, and the bus bar assembly at the same time as the separation space is not fully filled. However, when the expansion portion 420 expands to fill the insertion space, the expansion portion 420 may contact the components forming the insertion space at the same time.

In the embodiment, the insertion member 400 may be fixed at a predetermined position by the heat dissipation portion 295. In this case, the insertion member 400 may only come into contact with the heat dissipation portion or the accommodation case in which the heat dissipation part is located. Even in such a case, the expansion portion 420 may expand and come into contact with an adjacent component above the predetermined allowable temperature.

The expansion portion 420 may expand to cover the insertion space 288, thereby blocking the propagation path of heat or flame and delaying thermal propagation.

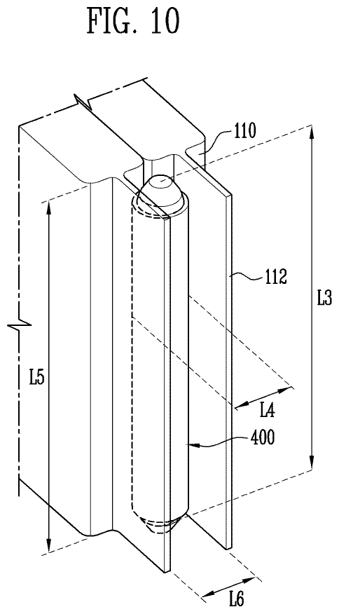

FIG. 10 illustrates a state in which the insertion member 400 is located in the insertion space 288 according to an embodiment of the present disclosure.

Referring to FIG. 10, a length L3 of the insertion member may be less than or equal to a length L5 of the main body in the height direction of the accommodation case 210. When the length L3 of the insertion member is greater than or equal to the length L5 of the main body in the height direction, the insertion member may protrude outside to the main body. The ease of assembly may be reduced and efficient use of space may be difficult. Therefore, the insertion member 400 having a length equal to or less than the length of the main body may be preferable.

Preferably, the length L3 of the insertion member in the height direction may be at least 80% of the length L5 of the main body to allow the expansion portion to be uniformly distributed in the height direction of the accommodation case and to delay thermal propagation through the insertion member. When the length of the insertion member is too short, the insertion space may be not efficiently covered even when the expansion part expands.

In addition, a maximum length L4 of the insertion member in the predetermined stacking direction may be less than or equal to the thickness of one of the plurality of battery cells. In addition, the length L4 of the insertion member in the direction in which the plurality of battery cells are stacked may be less than or equal to a distance L6 between the tab portions respectively located on two adjacent battery cells among the plurality of battery cells.

Referring to FIG. 10, the insertion member 400 may be stably located in the insertion space 288 when the length L4 of the insertion member in the X direction is less than or equal to the distance L6 between the tab portions.

On the other hand, the length L4 of the insertion member in the X direction may preferably be more than half of the distance L6 between the tab portions. The insertion member may occupy most of the insertion space and effectively cover the insertion space when the expansion portion expands with the above configuration.

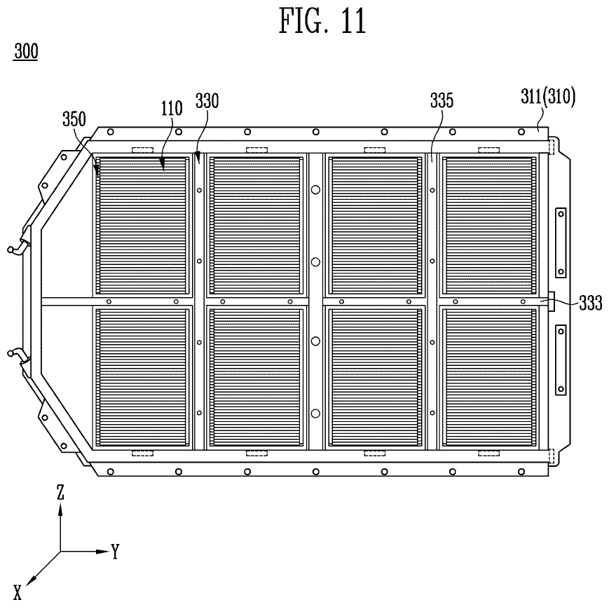

FIG. 11 illustrates a battery assembly according to another embodiment of the present disclosure.

Although the battery assembly described above is based on a battery module, FIG. 11 illustrates another example of the battery assembly having a battery pack form. That is, the battery assembly may have a CTP (Cell to Pack) structure in which the plurality of battery cells 110 are accommodated in the form of packs without the battery module.

Referring to FIG. 11, the battery assembly 300 includes a plurality of battery cells 110 stacked and arranged in a predetermined stacking direction, an accommodation case 310 accommodating the plurality of battery cells 110, and an insertion member located in an insertion space 350 formed between the accommodation case 310 and the plurality of battery cells 110 in the predetermined stacking direction. The insertion member includes a body portion having a cylindrical shape and an expansion portion covering at least a portion of the body portion and expanding when reaching a predetermined allowable temperature.

The insertion member is the same as described above, and the accommodation case 310 will be described in detail in FIG. 11.

The accommodation case 310 may include an accommodation body 311 for accommodating the plurality of battery cells 110 and an accommodation cover (not shown) coupled to the accommodation body 311. In addition, the accommodation case 310 may further include a partition that partitions the insertion space.

The partition 330 may further include a first frame 333 and a second frame 335 that partition the plurality of battery cells 110 horizontally and vertically. The first frame 333 and the second frame 335 may prevent deformation of the accommodation body 311, and may also support and separate the plurality of battery cells 110.

Since the present disclosure may be implemented in various forms, the scope of rights is not limited to the above-described embodiments. Therefore, as long as the modified embodiments include the elements of the present disclosure, they shall be deemed to fall within the scope of the present disclosure.

What is claimed is:

1. A battery assembly comprising:
a plurality of battery cells arranged in a predetermined stacking direction;
an accommodation case accommodating the plurality of battery cells; and
an insertion member located in an insertion space formed between the accommodation case and the plurality of battery cells in the predetermined stacking direction,
wherein the insertion member includes:
a body portion having a pillar shape; and
an expansion portion covering at least a portion of the body portion and expanding when reaching a predetermined allowable temperature.

2. The battery assembly according to claim 1, wherein the body portion extends in a height direction of the accommodation case.

3. The battery assembly according to claim 1, wherein the body portion includes a fire-resistant material.

4. The battery assembly according to claim 1, wherein at least one of opposite ends of the body portion has a tapered shape.

5. The battery assembly according to claim 1, wherein a thickness of the expansion portion is 0.01 mm or more and 100 mm or less.

6. The battery assembly according to claim 1, wherein the predetermined allowable temperature is 80° C. or more and 150° C. or less.

7. The battery assembly according to claim 1, wherein a volume of the expansion portion after expansion is twice or more and ten times or less than a volume of the expansion portion before expansion.

8. The battery assembly according to claim 1, wherein the expansion portion contacts one of the plurality of battery cells forming the insertion space, when the expansion portion expands.

9. The battery assembly according to claim 1, further comprising a bus bar assembly electrically connecting the plurality of battery cells,
wherein the insertion space is located between the bus bar assembly and the plurality of battery cells.

10. The battery assembly according to claim 9,
wherein the insertion space is separated into a plurality of separation spaces by tap portions of the plurality of battery cells, and
wherein the insertion member is inserted into one or more of the plurality of separation spaces.

11. The battery assembly according to claim 10, wherein the expansion portion contacts one or more of the tap portions forming the separation spaces, when the expansion portion expands.

12. The battery assembly according to claim 10, wherein the expansion portion contacts the bus bar assembly forming the separation spaces, when the expansion portion expands.

13. The battery assembly according to claim 10, further comprising a heat blocking member located between the plurality of battery cells to face an adjacent battery cell.

14. The battery assembly according to claim 1, further comprising a heat dissipation portion including an adhesive material applied to the accommodation case and having thermal conductivity.

15. The battery assembly according to claim 1, wherein the accommodation case comprises:
an accommodation body including an open upper face and accommodating the plurality of battery cells through the open upper face; and
an accommodation cover combined with the accommodation body and closing the open upper face.

16. The battery assembly according to claim 1, wherein the expansion portion has a latex form or an aerogel form.

17. The battery assembly according to claim 1, wherein the insertion member includes a plurality of insertion members.

18. The battery assembly according to claim 1, wherein a melting point of the body portion is higher than the predetermined allowable temperature.
